(19) United States
(12) Patent Application Publication
(10) Pub. No.: US 2004/0129079 A1
(43) Pub. Date: Jul. 8, 2004

(54) Acceleration sensor

(75) Inventors: Takashi Kato, Sannohe (JP); Masanori Yachi, Yokohama (JP); Hiroshi Tanaka, Yokohama (JP)

Correspondence Address: ARENT FOX KINTNER PLOTKIN & KAHN, PLLC, Suite 400, 1050 Connecticut Avenue, N.W., Washington, DC, 20036-5339, US

(73) Assignee: FUJITSU MEDIA DEVICES LIMTED

(21) Appl. No.: 10/739,145

(22) Filed: Dec. 19, 2003

Related U.S. Application Data
(63) Continuation of application No. PCT/JP02/10780, filed on Oct. 17, 2002.

(30) Foreign Application Priority Data
Jan. 31, 2002 (JP) 2002-023090

(51) Int. Cl. G01P 15/097; G01P 15/09

(52) U.S. Cl. 73/514.15; 73/514.36

(57) ABSTRACT

An acceleration sensor includes: a vibrator that is polarized in one direction; a weight that is connected to the vibrator; and a pair of electrodes that are adjacent to each other in the polarization direction and are placed on a first face of the vibrator. The pair of electrodes are located on a diagonal line on the first face of the vibrator. With this electrode structure, voltage is constantly produced in the pair of electrodes, no matter which one of the three axes of the vibrator receives acceleration. Thus, a non-directional acceleration sensor can be realized. Also, the sensitivity to tri-axial acceleration can be easily adjusted by changing the sizes of the electrodes in relation to the size of the vibrator.

### FIELD OF THE INVENTION

The present invention relates to piezoelectric acceleration sensors that are used to detect impact and acceleration applied to objects, and more particularly, to an acceleration sensor that detects a characteristic quantity generated by inertial force resulting from acceleration.

In recent years, electronic devices have been rapidly becoming smaller in size, and portable electronic devices such as notebook personal computers (PCs) are being more widely used. When a portable electronic device receives an unpredictable impact, it is necessary for the portable electronic device to detect the impact so that appropriate measures can be immediately taken to perform predetermined operations to maintain high reliability. So as to fulfill this requirement, an acceleration sensor, for example, is employed to prevent read/write errors when impact is applied to a hard disk drive (HDD) built in a notebook PC or a desk-top PC, or a magneto-optical (MO) disk or a digital video disk (DVD). Especially in a notebook PC, the HDD needs to detect acceleration applied in a direction perpendicular to the HDD housing plane so as to detect impact caused by an HDD housing plane in read/write operations of the head.

As the devices having acceleration sensors are becoming smaller in size and having a higher performance, acceleration sensors are also required to become smaller in size and to have a higher performance. Further, such acceleration sensors are required to detect acceleration in two or more axial directions: an in-plane direction and a direction perpendicular to the plane.

### BACKGROUND OF THE INVENTION

Japanese Unexamined Patent Publication No. 7-20144, for example, discloses a piezoelectric acceleration sensor that detects biaxial acceleration. This acceleration sensor is equipped with an acceleration detecting element that is mounted at an angle with the bottom face of a casing that houses the acceleration detecting element. Also, Japanese Unexamined Patent Publication No. 11-118823 discloses a method of detecting biaxial acceleration. In accordance with this method, a vibrator is tilted by arranging a supporting body, bonded to the vibrator, at an angle with the main plane. Japanese Unexamined Patent Publication No. 8-43432 discloses another method of detecting biaxial acceleration. In accordance with this method, polarization is provided at an angle with the plane of piezoelectric ceramics so as to be tilted to a plane perpendicular to the plane of the piezoelectric ceramics. Japanese Unexamined Patent Publication No. 11-211748 also discloses a method of detecting biaxial acceleration. In accordance with this method, a weight is provided at the end of a vibrator at a location decentered with respect to the width direction.

With the above conventional method in which the acceleration detecting element is tilted, however, the mounting process is complicated, and the production costs are very high. With the conventional method in which the supporting body is arranged at an angle, the device height becomes very large at the time of mounting, and the mounting process is also complicated. Further, the conventional method in which the polarization direction is tilted requires numerous production procedures, because electrode formation is carried out after polarization is provided and cutting is performed in a desired direction. With this method, the production costs are also very high. With the conventional method in which a weight is provided at the end of a vibrator, the detection sensitivity greatly varies due to location deviation of the weight.

Japanese Unexamined Patent Publication No. 2000-97707 discloses a small-sized, highly sensitive acceleration sensor that can solve the above problems. This acceleration sensor, also developed by the inventors of the present invention, has a vibrator and a weight connected to the vibrator. The weight is supported in a position deviating from the gravity center of the entire body including the vibrator. When acceleration is applied, the acceleration sensor detects a characteristic quantity (or slide vibration) from the vibrator in accordance with a rotation moment generated in the weight. By doing so, the acceleration applied can be measured. The vibrator of this acceleration sensor does not need to be large in size, and accordingly, this acceleration sensor is small in size while maintaining high detection sensitivity. However, this acceleration sensor can detect only unidirectional acceleration. In other words, this acceleration sensor is not a non-directional acceleration sensor that can detect tri-axial acceleration.

The inventors have also suggested small-sized, highly sensitive non-directional acceleration sensors in Japanese Patent Application Nos. 11-375813 and 12-351058.

An object of the present invention is to provide a small-sized, highly reliable non-directional acceleration sensor that includes a vibrator and a weight.

A more specific object of the present invention is to provide a small-sized, highly reliable acceleration sensor that can detect tri-axial acceleration with a mechanism different from any of the conventional non-directional acceleration sensors.

### DISCLOSURE OF THE INVENTION

To achieve the above objects, the present invention provides an acceleration sensor that includes: a vibrator that is polarized in one direction; a weight that is connected to the vibrator; and a pair of electrodes that are adjacent to each other in the polarization direction and are placed on a first face of the vibrator. In this acceleration sensor, the pair of electrodes are located on a diagonal line on the first face. With this electrode structure, voltage is constantly produced in the pair of electrodes, no matter which one of the three axes of the vibrator receives acceleration. Also, the sensitivity to tri-axial acceleration can be readily adjusted by changing the sizes of the electrodes in relation to the size of the vibrator, as will be described later.

### BRIEF DESCRIPTION OF THE DRAWINGS

FIG. 1A is a bottom view of an acceleration sensor in accordance with a first embodiment of the present invention;

FIG. 1B shows the relationship between the acceleration applying axes and the voltage (or electric charge) produced in the electrodes in accordance with the first embodiment;

FIG. 2 is a perspective view of the acceleration sensor in accordance with the first embodiment;

FIG. 3 illustrates an example structure of a detection circuit;

FIG. 4 is a perspective view illustrating a modification of the acceleration sensor in accordance with the first embodiment;

FIG. 5 is a perspective view illustrating another modification of the acceleration sensor in accordance with the first embodiment;

FIG. 6 is a perspective view illustrating an example electrode pattern formed on the weight;

FIG. 7 illustrates a modification of the acceleration sensor shown in FIG. 5;

FIG. 8A is a bottom view illustrating yet another modification of the acceleration sensor in accordance with the first embodiment;

FIG. 8B shows the relationship between the acceleration applying axes and the voltage (or electric charge) produced in the electrodes;

FIG. 9A is a bottom view of an acceleration sensor in accordance with a second embodiment of the present invention;

FIG. 9B shows the relationship between the acceleration applying axes and the voltage produced in the electrodes;

FIG. 10 is a perspective view of the acceleration sensor in accordance with the second embodiment;

FIG. 11 is a perspective view illustrating a modification of the acceleration sensor in accordance with the second embodiment;

FIG. 12 is a perspective view illustrating another modification of the acceleration sensor in accordance with the second embodiment;

FIG. 13 is a perspective view illustrating yet another modification of the acceleration sensor in accordance with the second embodiment;

FIG. 14A is a bottom view illustrating still another modification of the acceleration sensor in accordance with the second embodiment;

FIG. 14B shows the relationship between the acceleration applying axes and the voltage (or electric charge) produced in the electrodes;

FIG. 15A is a bottom view of an acceleration sensor in accordance with a third embodiment of the present invention;

FIG. 15B shows the relationship between the acceleration applying axes and the voltage produced in the electrodes;

FIGS. 16A and 16B are graphs showing the relationship between the sensitivity (mV/G) and the angle θ (°) of the separation groove shown in FIGS. 15A and 15B;

FIGS. 17A through 17G illustrate acceleration sensors in accordance with a fourth embodiment of the present invention;

FIG. 18A is a plan view of an acceleration sensor in accordance with a fifth embodiment of the present invention;

FIG. 18B is a section view of the acceleration sensor, taken along the line A-A of FIG. 18A;

FIG. 18C is a bottom view of the acceleration sensor in accordance with the fifth embodiment;

FIG. 19A is a plan view illustrating a modification of the acceleration sensor shown in FIGS. 18A through 18C;

FIG. 19B is a section view of the acceleration sensor, taken along the line B-B of FIG. 19A;

FIG. 20A is a plan view of an acceleration sensor in accordance with a sixth embodiment of the present invention;

FIG. 20B is a section view of the acceleration sensor, taken along the line C-C of FIG. 20A;

FIGS. 21A and 21B illustrate a modification of the acceleration sensor shown in FIGS. 20A and 20B;

FIG. 22 is a side view of an acceleration sensor in accordance with a seventh embodiment of the present invention;

FIG. 23 illustrates the characteristics of an acceleration sensor in accordance with an eighth embodiment of the present invention; and

FIGS. 24A through 24C illustrate acceleration sensors in accordance with a ninth embodiment of the present invention.

### DESCRIPTION OF THE PREFERRED EMBODIMENTS

(First Embodiment)

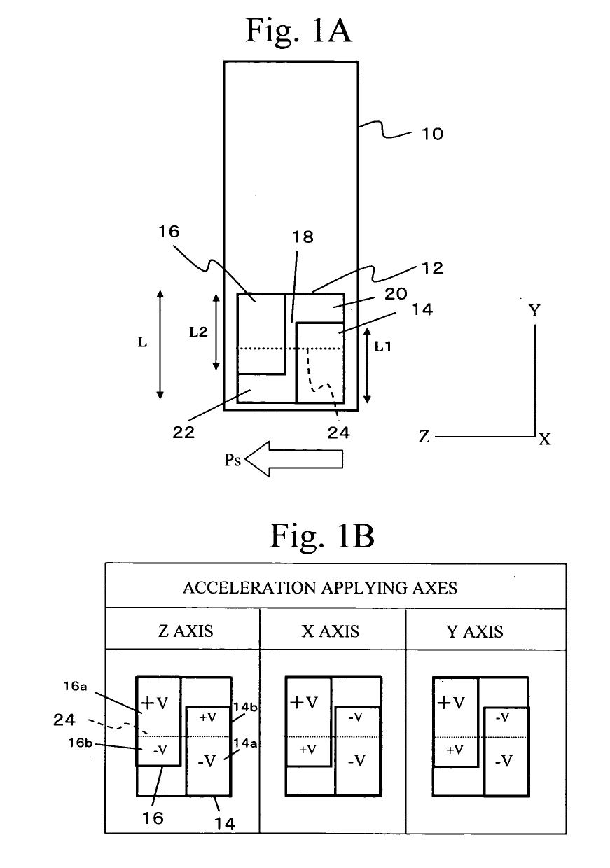

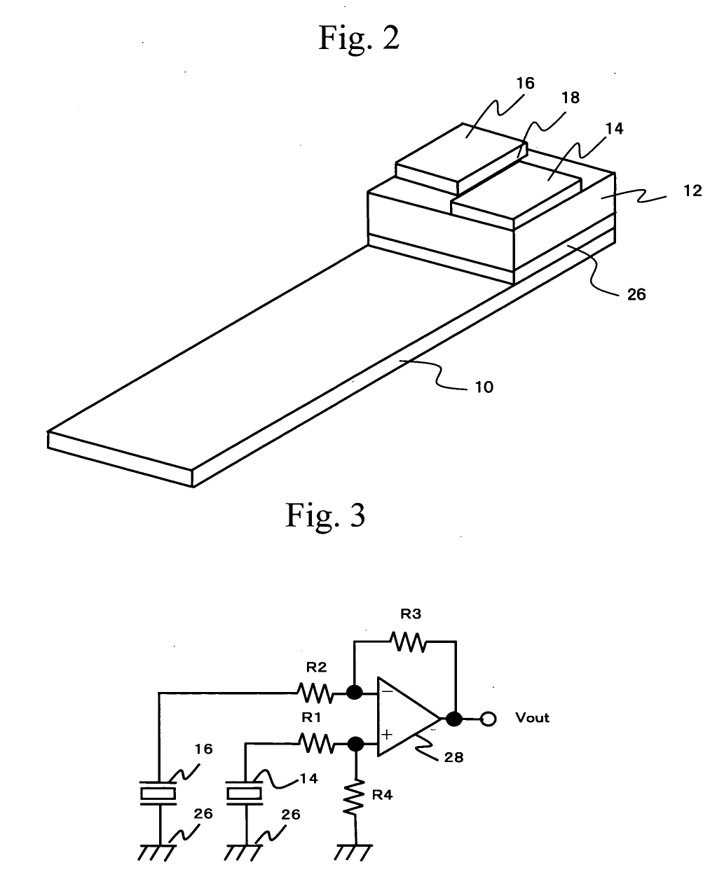

FIGS. 1A and 1B illustrate an acceleration sensor in accordance with a first embodiment of the present invention. More specifically, FIG. 1A is a bottom view of the acceleration sensor, and FIG. 1B illustrates the relationship between the acceleration applying axes and the voltage (or electric charge) produced in the electrodes. FIG. 2 is a perspective view of the acceleration sensor in accordance with this embodiment.

This acceleration sensor includes a vibrator 12 and a weight 10 connected to the vibrator 12. The weight 10 is supported at a location deviating from the gravity center of the entire body including the vibrator 12 and the weight 10. In the structure shown in FIG. 1A, the weight 10 is a rectangular plate, and the vibrator is attached to an end of the weight 10. Although each edge of the weight 10 is in line with each corresponding edge of the vibrator 12 in FIG. 2, each edge of the weight 10 is intentionally located at a distance from each corresponding edge of the vibrator 12 in FIG. 1A (the vibrator 12 being located slightly inside). This is mainly for ease of understanding of the structure shown in FIG. 1A. It is of course possible to actually position the vibrator 12 on the weight 10 in the same manner as shown in FIG. 1A. In either way, the functions and operation of the acceleration sensor remain unchanged.

The weight 10 is made of a metal of high density, or an insulating material such as alumina or flint glass. The weight 10 may be made of a single material, or two or more different materials. A material of higher density may be employed at the free end of the weight 10, while a material of lower density is employed at the opposite end, for example.

The vibrator 12 is a rectangular parallelepiped of piezoelectric ceramics. The piezoelectric ceramics is cut out of a ceramic crystal plate. For example, the vibrator 12 may be made of PZT-based piezoelectric ceramics with a relatively high electromechanical coupling coefficient. The cross section of the vibrator 12 may be square or rectangular. The vibrator 12 is polarized in the direction indicated by the arrow Ps. The polarization of piezoelectric ceramics is carried out by applying a high voltage to the area between the two end faces of a piezoelectric ceramic crystal plate. The vibrator 12 is attached to the weight 10 so that the polarization direction Ps is perpendicular to the longitudinal direction of the weight 10. For ease of explanation, X axis, Y axis, and Z axis are defined as shown in FIG. 1A. The X axis represents the direction perpendicular to the plane of the paper sheet. The Z axis represents the polarization direction Ps, and the Y axis represents the longitudinal direction of the weight 10.

Electrodes 14 and 16 are formed on a face (a first face) of the vibrator 12. Hereinafter, this face of the vibrator 12 will be referred to as the “electrode forming face”. So as to obtain a non-directional acceleration sensor that is capable of detecting tri-axial acceleration and easily adjusting the sensitivity in the three axial directions, the electrodes 14 and 16 of this embodiment are formed in the following manner.

The electrodes 14 and 16 are rectangular electrodes of the same size that are adjacent to each other in the polarization direction Ps, with a separation groove 18 existing between the two electrodes 14 and 16. The separation groove 18 extends in the Y-axis direction. In the acceleration sensor shown in FIGS. 1A and 2, the separation groove 18 is formed by the two facing electrodes 14 and 16, and the vibrator 12 does not have a groove formed therein. However, it is possible to form a groove in the vibrator 12, as will be mentioned later.

The electrodes 14 and 16 are a pair of detection electrodes that detect voltage according to acceleration applied. (Hereinafter, the electrodes 14 and 16 will be referred to as the “detection electrodes”.) The detection electrodes 14 and 16 are located on a diagonal line on the electrode forming face of the vibrator 12. In other words, the detection electrodes 14 and 16 are set back in the Y-axis direction from a center line 24 that divides the vibrator 12 into two in the polarization direction Ps. The detection electrode 14 is set back from the free end of the weight 10, while the detection electrode 16 is set back from the fixed end of the weight 10. The detection electrodes 14 and 16 also deviate from the center line 24 in the positive and negative directions of the Y axis. The detection electrodes 14 and 16 are also located diagonally with respect to the center line 24. In other words, the detection electrodes 14 and 16 are point-symmetrically located with respect to the center point of the vibrator 12.

The area of each of the detection electrodes 14 and 16 is larger than a fourth of the area of the electrode forming face, but smaller than a half of the area of the electrode forming face. With the length of the vibrator 12 in the direction perpendicular to the polarization direction Ps being L, and the lengths of the detection electrodes 14 and 16 being L1 and L2, respectively, the relationship between the length L and the length L1 (or L2) can be expressed as follows: 0.5<L1(=L2)/L<1. As the detection electrodes 14 and 16 are arranged as described above, two exposed regions 20 and 22 that are not covered with the detection electrodes 14 and 16 are formed on the electrode forming face of the vibrator 12.

As shown in FIG. 2, a ground electrode 26 is formed on the face opposite to the ground forming face of the vibrator 12. The ground electrode 26 is valid for both the detection electrodes 14 and 16. The ground electrode 26 is attached to the weight 10 with a conductive adhesive. The ground electrode 26 may have a single-layer structure of gold (Au), or a multi-layer structure of NiCr/Au or Ni/Au, for example. If the weight 10 is made of a conductive material such as a metal, an extension line is connected to the weight 10 so that the ground electrode 26 can be connected to a detection circuit that will be described later. If the weight 10 is made of an insulating material, an electrode as opposed to the ground electrode 26 is formed on the weight 10, so that the ground electrode 26 can be connected to the detection circuit. The detection electrodes 14 and 16 are attached onto a wiring board, and are electrically connected to electrodes formed on the wiring board, as will be described later. It should be understood that the detection electrodes 14 and 16 and the ground electrode 26 shown in FIGS. 1A and 2 are exaggeratedly thick, for ease of explanation.

FIG. 1B shows the relationship between the acceleration applying axes and the voltage (or electric charge) produced in the electrodes 14 and 16. When acceleration is applied in the Z-axis direction, the vibrator 12 has slide vibration in the opposite directions of the Z axis, with the center line 24 being the boundary. As the vibrator 12 is polarized in the Z-axis direction, the slide vibration in the opposite directions of the Z axis causes the electrodes 14 and 16 to have the voltage shown in FIG. 1B. For ease of explanation, the electrode 14 is provisionally divided into two electrode parts 14a and 14b, with the center line 24 being the dividing line. Likewise, the electrode 16 is provisionally divided into two electrode parts 16a and 16b. When acceleration is applied in the Z-axis direction, a positive voltage +V is produced in the electrode part 16a. At the same time, a positive voltage +v is produced in the electrode part 14b that receives the same slide vibration as the slide vibration the electrode part 16a receives. The size of the voltage (electric charge) produced is represented by the capital “V” and the small “v”. Since the electrode part 16a has a larger area than the electrode part 14b, the voltage +V produced in the electrode part 16a is higher than the voltage +v produced in the electrode 14b. Meanwhile, as the electrode part 14a and the electrode part 16b receive slide vibration in the opposite direction, a negative voltage −V and a negative voltage −v (|V| being greater than |v|) are produced in the electrode part 14a and the electrode part 16b, respectively. As a result, a voltage of “−V+v” is produced in the detection electrode 14, while a voltage of “+V−v” is produced in the detection electrode 16. When acceleration is applied in the opposite direction of the Z axis, a voltage of “+V−v” is produced in the detection electrode 14, while a voltage of “−V+v” is produced in the detection electrode 16. In this manner, the acceleration applied in the Z-axis direction can be detected.

When acceleration is applied in the X-axis direction, the voltages shown in FIG. 1B are produced in the detection electrodes 14 and 16. Because of the relationship between the polarization Ps and the stress caused in the X-axis direction in the vibrator 12, a voltage of “−V−v” is produced in the detection electrode 14, and a voltage of “+V+v” is produced in the detection electrode 16. Likewise, when acceleration is applied in the Y-axis direction, the voltages shown in FIG. 1B are produced in the detection electrodes 14 and 16. Because of the relationship between the polarization Ps and the stress caused in the Y-axis direction in the vibrator 12, a voltage of “−V−v” is produced in the detection electrode 14, and a voltage of “+V+v” is produced in the detection electrode 16. When acceleration is applied in the directions of two or more different axes at the same time, voltages that are proportional to acceleration values obtained by dividing the acceleration among the axes are produced. If acceleration is applied in such a manner that a voltage V is produced at an angle of 45° with respect to the two-dimensional plane including the Z axis and the X axis, for example, a voltage of “(−1/√2)×V” is produced in the electrode part 14a, and a voltage of “(+1/√2)×V” is produced in the electrode part 16a. On the other hand, the voltages in the electrode parts 14b and 16b cancel each other out. Ultimately, a voltage of “(−1/√2)×V” is produced in the detection electrode 14, and a voltage of “(+1/√2)×V” is produced in the detection electrode 16.

In the above manner, voltages are produced in the detection electrodes 14 and 16, no matter which one of the three axes receives acceleration. Thus, non-directional acceleration detection can be performed.

Here, the ratios of the lengths L1 and L2 of the detection electrodes 14 and 16 to the length L of the vibrator 12, i.e., L1/L and L2/L, determine the detection sensitivity to acceleration. If the ratios L1/L and L2/L are made larger by increasing the lengths L1 and L2, the sensitivity in the Z-axis direction decreases, while the sensitivity in the X-axis and Y-axis directions increases. If the lengths L1 and L2 are reduced, the sensitivity in the Z-axis direction increases, while the sensitivity in the X-axis and Y-axis directions decreases. Accordingly, the ratios L1/L and L2/L should be determined suitably for actual use, so that the sensitivity distribution ratio among the three axes can be suitably adjusted.

Although it is preferable that the detection electrodes 14 and 16 have the same areas and the same lengths (L1=L2), there can be small differences between them as long as the above detection principles are maintained.

FIG. 3 is a circuit diagram showing an example structure of the detection circuit. This detection circuit includes a differential amplifier 28 and resistances R1 through R4. The detection electrode 14 is connected to the non-reversed input terminal of the differential amplifier 28 via the resistance R1. The detection electrode 16 is connected to the reversed input terminal of the differential amplifier 28 via the resistance R2. The differential amplifier 28 differential-amplifies the voltage produced in the electrodes 14 and 16, and outputs the amplified voltage as a detected output voltage Vout.

The vibrator 12 is produced in the following manner. Electrode layers are first formed on the faces opposite to each other of a ceramic crystal plate. Each of the electrode layers has a multi-layer structure containing different metals. An electrode layer having a double-layer structure, for example, contains Ni or NiCr as a base layer, and Au formed on the base layer. Those electrode layers can be formed by a known technique, such as sputtering, sintering, vapor deposition, electroplating, or electroless plating. After the formation of the electrode layers, patterning is performed on the electrode layers by etching or laser trimming so as to form the detection electrodes 14 and 16. At this point, the separation groove 18 is also formed. The ceramic crystal plate is then cut into ceramic crystal pieces to serve as vibrators 12 by dicing.

So far, an acceleration sensor in accordance with the first embodiment of the present invention has been described. With the above detection electrodes 14 and 16, it is possible to obtain an acceleration sensor that can detect tri-axial acceleration with a simple mechanism. Also, the sensitivity distribution ratio among the three axes can be easily adjusted by changing the arrangement of the detection electrodes 14 and 16.

Modifications and changes can be made to the above acceleration sensor, as long as the principles of the acceleration detection described above are maintained. In the following, several examples of such modifications will be described.

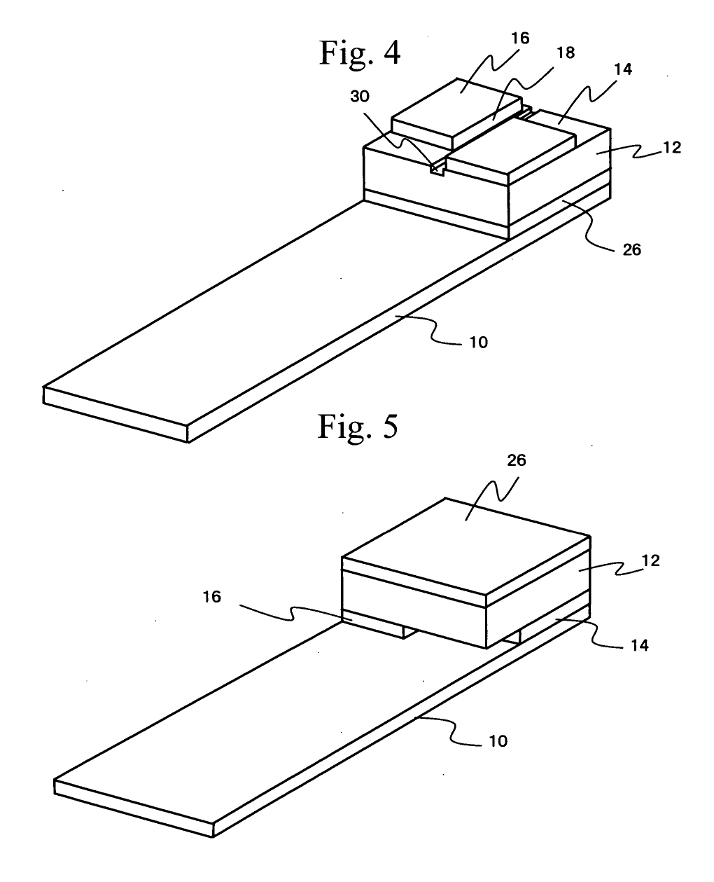

As shown in FIG. 4, a separation groove 30 may be formed in the vibrator 12. This separation groove 30 extends in the Y-axis direction, and is integrated with the separation groove 18. With the separation groove 30 formed in the vibrator 12, slide vibration caused by acceleration can be more efficiently generated. The depth and width of the separation groove 30 can be arbitrarily determined in accordance with required sensitivity. In a case where the separation groove 30 is employed, a step of forming the separation groove 30 needs to be added to the production process.

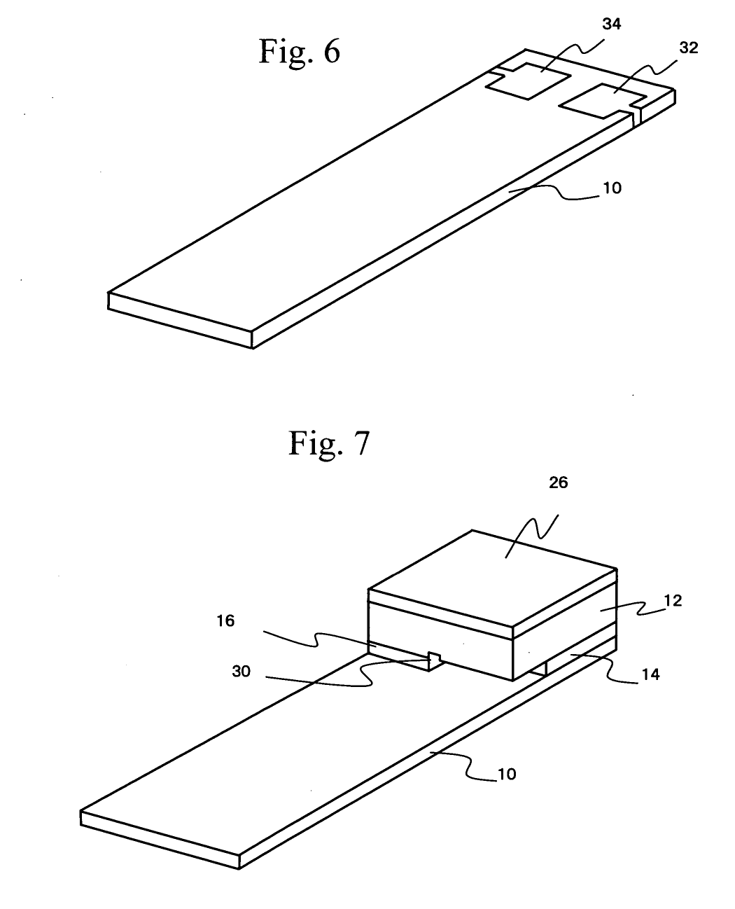

FIG. 5 is a perspective view of an acceleration sensor that has the vibrator 12 reversed and then attached to the weight 10. In this acceleration sensor, the detection electrodes 14 and 16 are bonded to the weight 10 with an anisotropic conductive adhesive. The weight 10 is made of an insulating material such as alumina or flint glass. Further, electrode patterns 32 and 34 corresponding to the detection electrodes 14 and 16, respectively, are formed on the weight 10, as shown in FIG. 6. The electrode patterns 32 and 34 extend along the side faces of the weight 10, to the face on the other side for external connection. Alternatively, a flexible wiring board (not shown) may be mounted on the electrode patterns 32 and 34 so as to obtain connection with the outside without extending to the face on the other side.

This acceleration sensor shown in FIG. 5 can also detect tri-axial acceleration. FIG. 7 illustrates a modification of the structure shown in FIG. 5. This modification shown in FIG. 7 has the separation groove 30 in the vibrator 12.

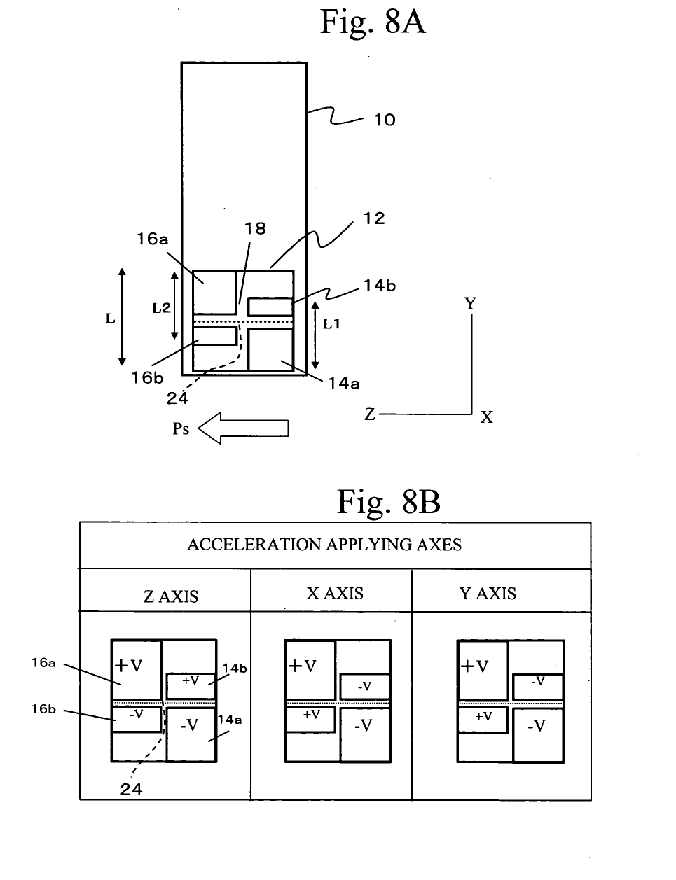

FIGS. 8A and 8B illustrate another modification of the first embodiment. FIG. 8A is a bottom view of an acceleration sensor that is obtained as a result of the modification. FIG. 8B shows the relationship between the acceleration applying axes and the voltage produced in the electrodes. The above explanation with reference to FIG. 1B was made on the assumption that the detection electrode 14 includes the electrode parts 14a and 14b, and that the detection electrode 16 includes the electrode parts 16a and 16b. In the structure shown in FIG. 8A, on the other hand, the detection electrode 14 is actually divided into the two electrode parts 14a and 14b, with the center line 24 being the dividing line. Likewise, the detection electrode 16 is actually divided into the two electrode parts 16a and 16b, with the center line 24 being the dividing line. The principles of acceleration detection employed in this modification are the same as those explained with reference to FIG. 1B. The electrode parts 14a and 14b are electrically connected to each other at a stage before the differential amplifier 28 shown in FIG. 3. Likewise, the electrode parts 16a and 16b are electrically connected to each other. This connection is carried out by means of a wiring pattern on a printed wiring board (not shown in FIGS. 8A and 8B) on which the acceleration sensor is to be mounted. With such an electrode structure, tri-axial acceleration can be detected, as shown in FIG. 8B. Also, the sensitivity distribution ratio among the three axes can be readily adjusted by controlling the sizes of the electrode parts 14b and 16b such as the lengths in the Y-axis direction.

It should be noted that the dividing of the detection electrodes 14 and 16 is not limited to the manner shown in FIG. 8A. For example, it is possible to divide the detection electrode 14 in such a manner that the length L1 of the detection electrode 14 is divided into two equal lengths. Likewise, it is possible to divide the detection electrode 16 in such a manner that the length L2 of the detection electrode 16 is divided into two equal lengths. As long as the detection electrodes 14 and 16 have the lengths L1 and L2 in total (L1 being normally equal to L2), dividing lines can be arbitrarily chosen. Furthermore, it is theoretically possible to divide each of the detection electrodes 14 and 16 into three or more electrode parts.

As another modification, the vibrator 12 may be made of a piezoelectric polycrystalline material or a piezoelectric single-crystal material such as lithium niobate (LiNbO₃) or lithium tantalate (LiTaO₃), instead of PZT-based piezoelectric ceramics.

As described so far, the first embodiment of the present invention can provide a small-sized, highly sensitive non-directional acceleration sensor that can easily adjust detection sensitivity.

(Second Embodiment)

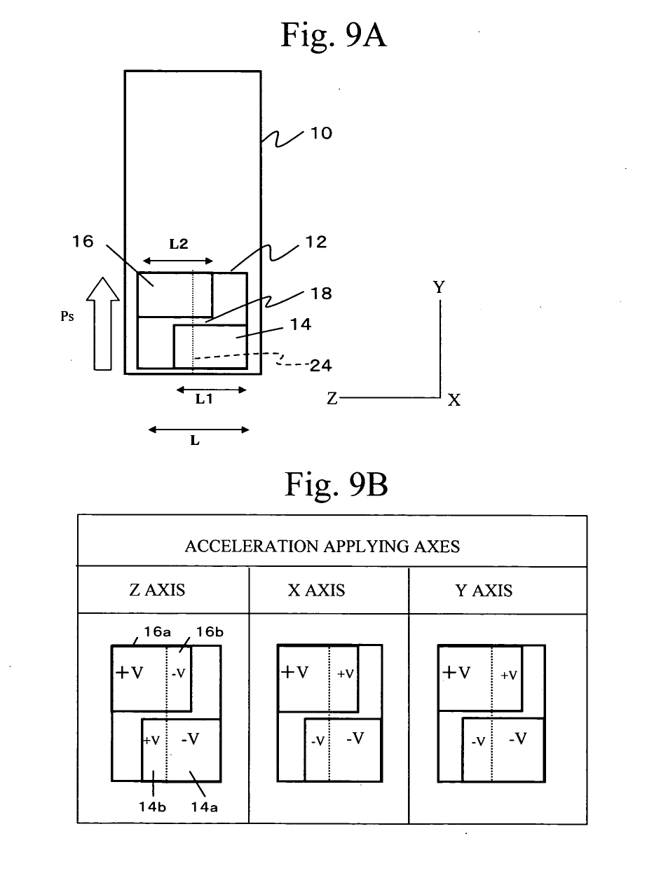

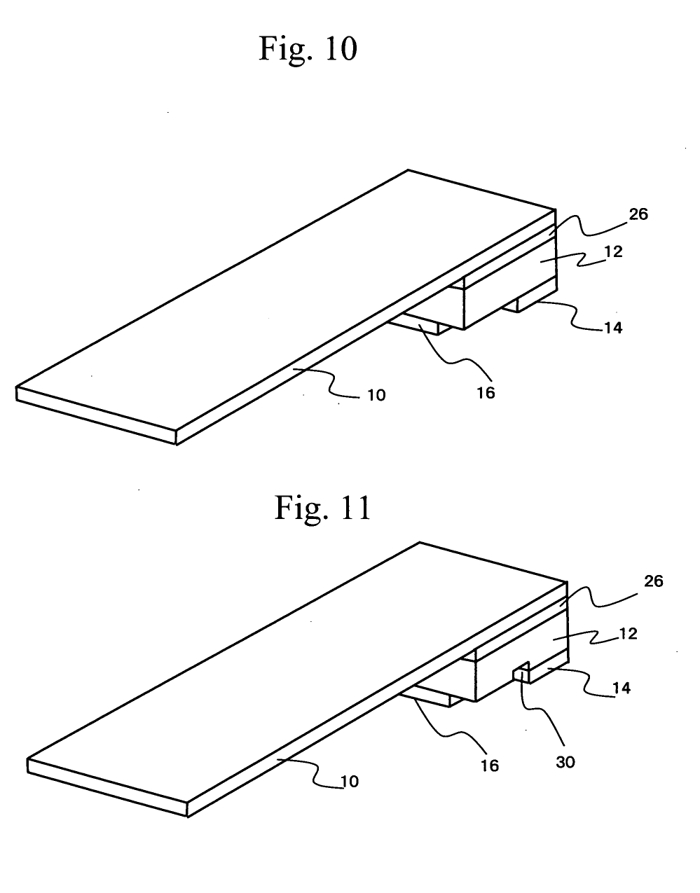

FIGS. 9A and 9B illustrate an acceleration sensor in accordance with a second embodiment of the present invention. FIG. 9A is a bottom view of the acceleration sensor, and FIG. 9B shows the relationship between the acceleration applying axes and the voltage produced in the electrodes. FIG. 10 is a perspective view of the acceleration sensor in accordance with this embodiment.

In the acceleration sensor in accordance with this embodiment, the polarization direction of the vibrator 12 is matched with the longitudinal direction of the weight 10 (the Y-axis direction), and the detection electrodes 14 and 16 are adjacent to each other in that direction. The detection electrodes 14 and 16 are arranged on a diagonal line on the electrode forming face of the vibrator 12. The other aspects of this embodiment are the same as those of the first embodiment. As shown in FIG. 9B, voltages in accordance with tri-axial acceleration are produced in the detection electrodes 14 and 16. Since the relationship between the acceleration applying axes and the voltage produced is the same as that shown in FIG. 1B, and therefore, explanation of it is not repeated herein.

In this manner, a non-directional acceleration sensor can be realized with a structure in which the polarization direction Ps is matched with the longitudinal direction of the weight 10, and the two detection electrodes 14 and 16 are adjacent to each other in that direction and are arranged on a diagonal line.

FIG. 11 illustrates a modification of the acceleration sensor shown in FIGS. 9A and 10. As shown in FIG. 11, the separation groove 30 is formed in the vibrator 12. The separation groove 30 extends in the direction of the Z axis shown in FIG. 9A.

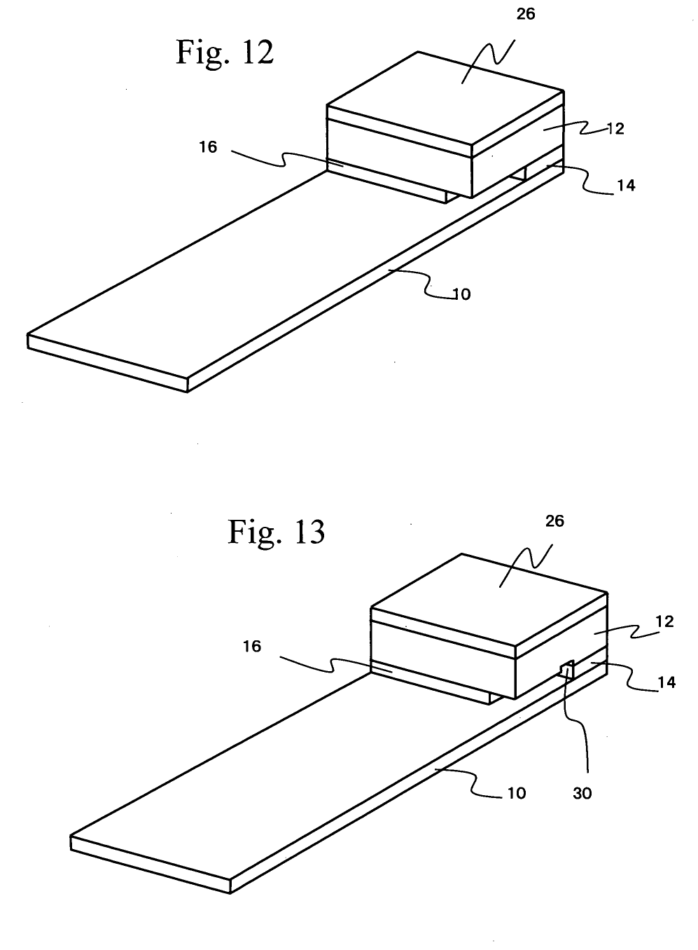

FIG. 12 illustrates another modification of the acceleration sensor shown in FIGS. 9A and 10. As shown in FIG. 12, the detection electrodes 14 and 16 are located on the side of the weight 10. The same electrode patterns as the electrode patterns 32 and 34 shown in FIG. 6 are also formed on the weight 10 shown in FIG. 12. However, the positions of those electrode patterns are determined so as to match with the positions of the detection electrodes 14 and 16.

FIG. 13 illustrates a modification of the acceleration sensor shown in FIG. 12. As shown in FIG. 13, the separation groove 30 is formed in the vibrator 12. The separation groove 30 extends in the direction of the Z axis shown in FIG. 9A.

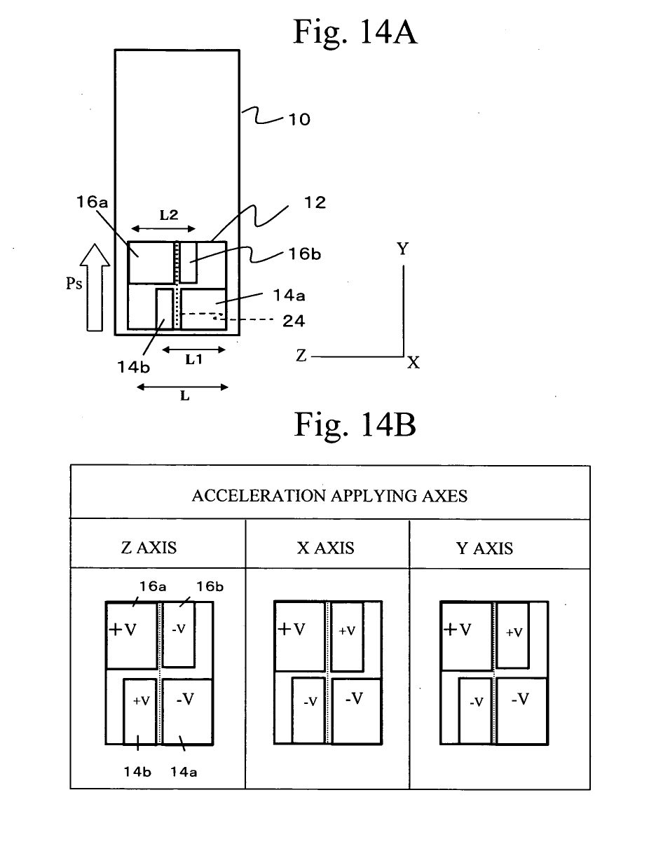

FIGS. 14A and 14B illustrate yet another modification of the second embodiment. FIG. 14A is a bottom view of an acceleration sensor that is obtained as a result of the modification. FIG. 14B shows the relationship between the acceleration applying axes and the voltage produced in the electrodes. In the electrode structure shown in FIG. 14B, the detection electrode 14 is actually divided into the two electrode parts 14a and 14b, with the center line 24 being the dividing line. Likewise, the detection electrode 16 is actually divided into the two electrode parts 16a and 16b, with the center line 24 being the dividing line. The principles of acceleration detection employed in this modification are the same as those explained with reference to FIG. 1B, and the relationship shown in FIG. 14B is the same as that shown in FIG. 9B. The electrode parts 14a and 14b are electrically connected to each other at a step before the differential amplifier 28 shown in FIG. 3. Likewise, the electrode parts 16a and 16b are electrically connected to each other. This connection is carried out by means of a wiring pattern on a printed wiring board (not shown in FIGS. 14A and 14B) on which the acceleration sensor is to be mounted.

So far, acceleration sensors in accordance with the second embodiment of the present invention have been described. Using the detection electrodes 14 and 16 having the above structure, an acceleration sensor that can detect tri-axial acceleration with a simple mechanism can be realized. Also, the sensitivity distribution ratio among the three axes can be readily adjusted by changing the patterns of the detection electrodes 14 and 16.

(Third Embodiment)

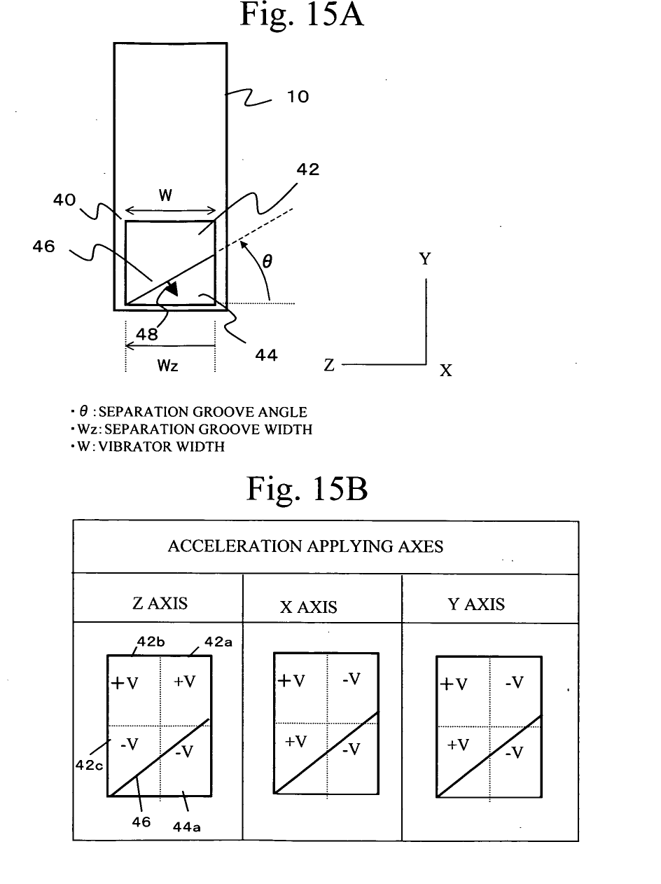

FIGS. 15A and 15B illustrate an acceleration sensor in accordance with a third embodiment of the present invention. FIG. 15A is a bottom view of the acceleration sensor, and FIG. 15B shows the relationship between the acceleration applying axes and the voltage produced in the electrodes.

The acceleration sensor in accordance with the third embodiment includes a vibrator 40 that is polarized in one direction, and the weight 10 that is connected to the vibrator 40. This acceleration sensor further includes two electrodes 42 and 44 that are arranged in such a manner as to divide the electrode forming face of the vibrator 40 asymmetrically into two areas. The facing edges of the two electrodes 42 and 44 are tilted with respect to the polarization direction of the vibrator 40. In the structure shown in FIG. 15A, the vibrator 40 is made of piezoelectric ceramics such as PZT, and is polarized in the Z-axis direction. The electrodes 42 and 44 are detection electrodes that are adjacent to each other, with a separation groove 46 being interposed in between. The separation groove 46 is formed by the facing edges of the detection electrodes 42 and 44. More specifically, the separation groove 46 is obtained when patterning is performed on an electrode layer to form the electrodes on the vibrator 40 made of piezoelectric ceramics. The separation groove 46 may include a groove formed in the vibrator 40, if necessary. The separation groove 46 is at an angle of θ with respect to the polarization direction (the Z-axis direction). As will be described later, the angle of the separation groove 46 affects the sensitivity of the acceleration sensor.

Further, the ground electrode described earlier is also formed on the opposite side of the vibrator 40.

As shown in FIG. 15B, voltage is produced in the detection electrodes 42 and 44 in accordance with acceleration applied to the axes. For the sake of convenience, explanation of the relationship shown in FIG. 15B will be made on the assumption that the detection electrode 42 includes electrode parts 42a, 42b, and 42c, and that the detection electrode 44 includes an electrode part 44a. The remaining relatively small electrode parts have little influence on the above electrodes parts, and therefore, can be omitted. When acceleration is applied in the Z-axis direction, the electrode parts 42a through 42c have the voltages shown in FIG. 15B, and the total voltage in the detection electrode 42 is V (=+V+V−V). Meanwhile, as a voltage of −V is produced in the electrode part 44a, the total voltage in the detection electrode 44 is −V. When acceleration is applied in the X-axis and Y-axis directions, a voltage of V is produced in the detection electrode 42, while a voltage of −V is produced in the detection electrode 44. In this manner, a positive voltage is invariably produced in the detection electrode 42, while a negative voltage is invariably produced in the detection electrode 44, no matter which axis receives acceleration.

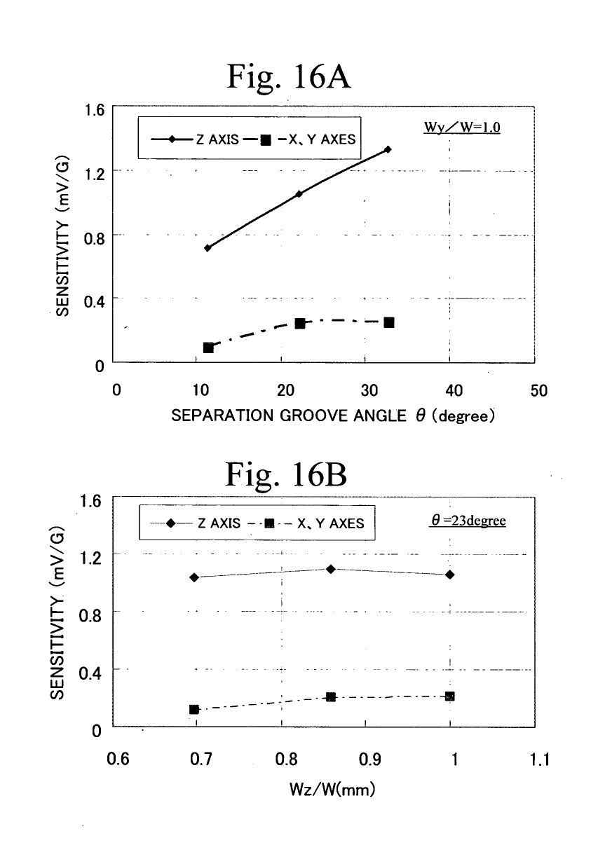

FIG. 16A is a graph showing the relationship between the angle θ (°) of the separation groove 46 and the sensitivity (mV/G). FIG. 16B is a graph showing the relationship between the sensitivity (mV/G) and the ratio of the width Wz of the separation groove 46 to the width W of the vibrator 40. As shown in FIG. 16A, when the angle of the separation groove 46 is increased from 10°, the sensitivity to acceleration in the Z-axis direction linearly increases, while the sensitivity to acceleration in the X-axis and Y-axis directions does not exhibit a great change. It should be noted that this graph shows a case where the length Wy of the vibrator 40 in the Y-axis direction is equal to the length W of the vibrator 40 in the X-axis direction (Wy/W=1.0), which is to say, the electrode forming face of the vibrator 40 takes on a square shape. On the other hand, when the ratio of Wz/W is varied from 1 to 0.7, the sensitivity to tri-axial acceleration does not exhibit a noticeable change, as shown in FIG. 16B. It should be noted that the graph shown in FIG. 16B shows a case where the angle θ of the separation groove 46 is 23°. As can be seen from FIG. 16A, the sensitivity to acceleration in the X-axis and Y-axis directions becomes substantially steady when the angle θ is 23°. Changing the ratio of Wz/W is parallel-moving the formation position of the separation groove 46 from the position shown in FIG. 15A (where Wz/W is 1) in the direction indicated by the arrow 48 (or in the opposite direction to the direction indicated by the arrow 48).

In view of the above facts, the sensitivity to acceleration in the Z-axis direction can be adjusted over a wide range by changing the angle of the separation groove 46. Therefore, when the acceleration sensor is designed, the angle of the separation groove 46 is determined so as to obtain a desired sensitivity.

In a case where the separation groove 46 is straight, with the ratio of Wz/W being 1 and the angle θ being smaller than 45°, the detection electrode 42 takes on a trapezoidal shape, and the detection electrode 44 takes on a triangular shape. If the separation groove 46 is moved in the direction indicated by the arrow 48 so that the ratio of WZ/W becomes smaller than 1, the detection electrode 42 takes on a pentagonal shape, and the detection electrode 44 takes on a triangular shape. If the separation groove 46 is moved in the opposite direction to the direction indicated by the arrow 48, both the detection electrode 42 and 44 take on a quadrangular (or trapezoidal) shape. Accordingly, the characteristics of the detection electrodes 42 and 44 of the third embodiment of the present invention can be distinguished by the shapes. One of the detection electrodes 42 and 44 may lie across all four equally divided regions of the electrode forming face. The detection electrodes 42 and 44 may have different areas or area ratios from each other.

At least one of the detection electrodes 42 and 44 may be divided into two or more electrode parts, and the divided electrode parts may be electrically connected to one another.

As described so far, the third embodiment of the present invention can provide a small-sized, highly sensitive non-directional acceleration sensor that can easily adjust detection sensitivity.

(Fourth Embodiment)

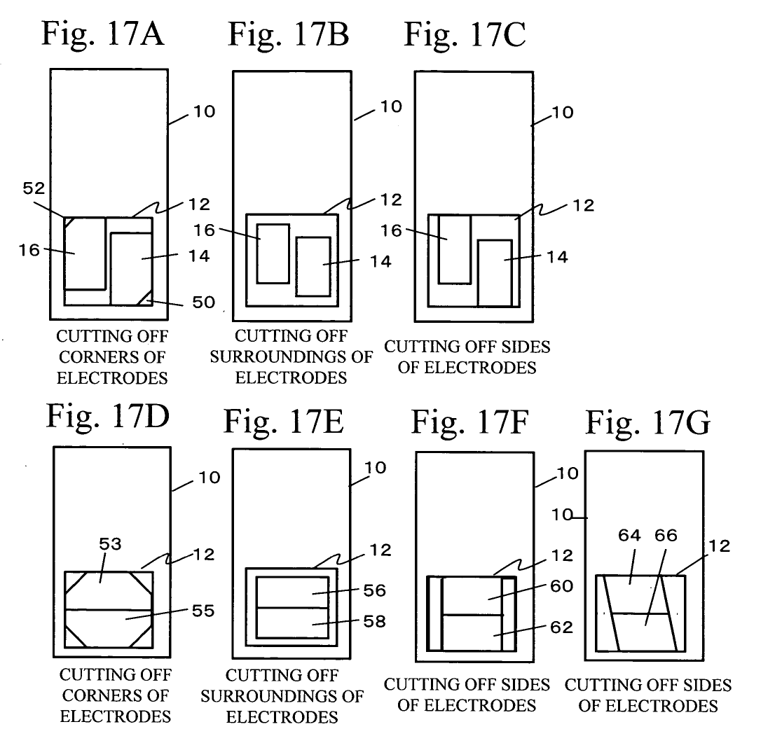

FIGS. 17A through 17G illustrate acceleration sensors in accordance with a fourth embodiment of the present invention. This embodiment is characterized by an electrode structure that is designed to avoid adverse influence from “chipping” caused when vibrators are cut out of a piezoelectric ceramic crystal plate by dicing or the like. “Chipping” means exfoliation of an electrode pattern during a dicing process or the like. Chipping causes unbalanced electric charge among the detection electrodes, often resulting in a decrease of detection sensitivity to acceleration. Chipping might also cause variations in sensitivity among acceleration sensors. Chipping is caused in the vicinity of the cutting lines of each piezoelectric ceramic crystal plate, especially at the corners of the cutting lines. It is therefore necessary to form detection electrodes at such locations as to avoid the regions in which chipping might be caused.

The detection electrodes 14 and 16 shown in FIG. 17A are set back from corners 50 and 52 of the vibrator 12. When patterning is performed on an electrode layer formed on a piezoelectric ceramic crystal plate, the electrode layer parts are removed from the corners 50 and 52. FIG. 17B illustrates an electrode structure in which the side faces of the detection electrodes 14 and 16 in the longitudinal direction and the width direction are set back from the edges of the vibrator 12. Since not only the corners but also the side faces are set back from the edges of the vibrator 12, this electrode structure is more preferable than the electrode structure shown in FIG. 17A in terms of prevention of chipping. FIG. 17C illustrates an electrode structure in which only the side faces of the detection electrodes 14 and 16 in the longitudinal direction are set back from the edges of the vibrator 12.

The electrodes structures shown in FIGS. 17A through 17C can be employed not only for the electrodes shown in FIG. 15A but also for other electrodes. FIGS. 17D through 17G illustrate other examples of electrode structures that can avoid chipping. FIG. 17D illustrates a structure in which the corners of detection electrodes 53 and 55 on the vibrator 12 are cut off. FIG. 17E illustrates a structure in which the side faces of detection electrodes 56 and 58 on the vibrator 12 in the longitudinal direction and the width direction are set back from the edges of the vibrator 12. FIG. 17F illustrates a structure in which the side faces of detection electrodes 60 and 62 on the vibrator 12 in the width direction are set back from the edges of the vibrator 12. FIG. 17G illustrates a structure in which the side faces of detection electrodes 64 and 66 on the vibrator 12 in the width direction are diagonally cut so as to be set back from the edges of the vibrator 12.

In the above manners, the detection electrodes are set back from the corners and edges of the vibrator 12, so that electric charge can be picked up evenly from the detection electrodes. Thus, variations in sensitivity among the detection electrodes and acceleration sensors can be eliminated.

It is also possible to employ a structure in which the ground electrode 26 is set back from the edges of the vibrator 12.

(Fifth Embodiment)

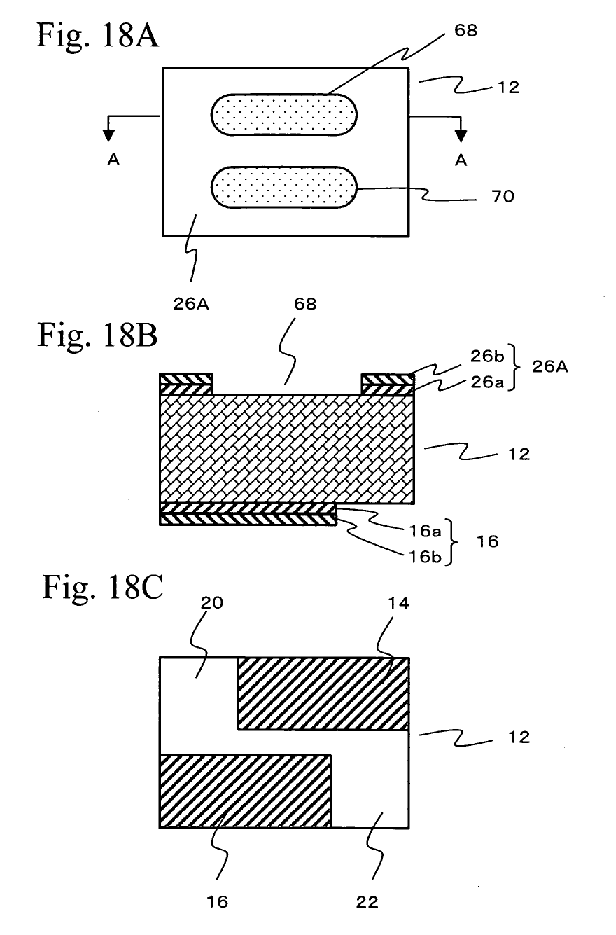

FIGS. 18A through 18C illustrate an acceleration sensor in accordance with a fifth embodiment of the present invention. More specifically, FIG. 18A is a plan view of the acceleration sensor, FIG. 18B is a section view of the acceleration sensor, taken along the line A-A of FIG. 18A, and FIG. 18C is a bottom view of the acceleration sensor. This embodiment is characterized by the structure of the ground electrode.

The ground electrode 26 of the first embodiment described earlier covers the entire area of a face of the vibrator 12. On the other hand, the ground electrode 26A of the acceleration sensor shown in FIGS. 18A through 18C has oval-shaped openings 68 and 70. The vibrator 12 is exposed through the openings 68 and 70. The ground electrode 26A has a double-layer structure that includes a base layer 26a of NiCr and a surface layer 26b of gold. The openings 68 and 70 can be formed by etching or laser trimming. The ground electrode 26A is bonded and secured to the weight 10 with a conductive adhesive. The conductive adhesive exhibits higher adhesion to piezoelectric ceramics used for the vibrator 12 than to gold. Accordingly, the openings 68 and 70 serve to increase the adhesion of the adhesive (an anchor effect). As the adhesive strength increases, the reliability in conductivity and shock resistance of the bonding layer increases.

In a case where the detection electrodes 14 and 16 are bonded to the weight 10, the exposed regions 20 and 22 shown in FIG. 1A serve to increase the adhesion of the anisotropic conductive adhesive.

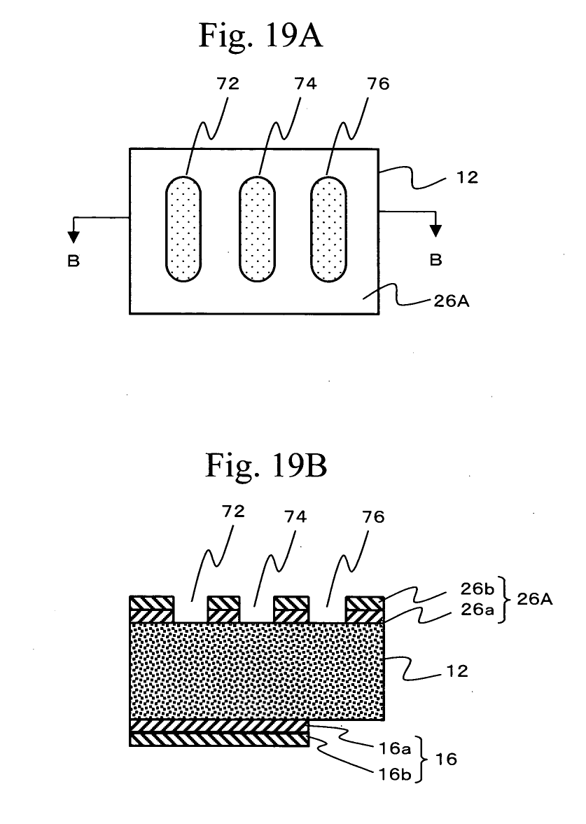

FIGS. 19A and 19B illustrate a modification of the acceleration sensor shown in FIGS. 18A through 18C. FIG. 19A is a plan view of this modified acceleration sensor, and FIG. 19B is a section view of the acceleration sensor, taken along the line B-B of FIG. 19A. In this modification, the ground electrode 26A has three oval-shaped openings 72, 74, and 76. These openings 72, 74, and 76 extend in a different direction from the openings 68 and 70 shown in FIG. 18A. The vibrator 12 is exposed through the openings 72, 74, and 76. The ground electrode 26A shown in FIGS. 19A and 19B have the same functions and effects as the ground electrode 26A shown in FIGS. 18A through 18C.

It should be noted that the shape and the number of openings are not limited to the above examples, but may be arbitrarily selected.

(Sixth Embodiment)

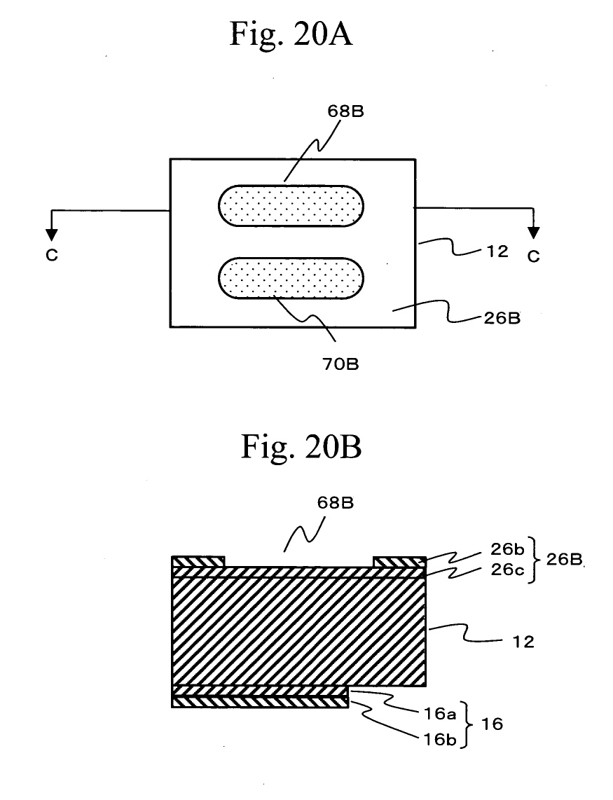

FIGS. 20A and 20B illustrate an acceleration sensor in accordance with a sixth embodiment of the present invention. FIG. 20A is a plan view of this acceleration sensor, and FIG. 20B is a section view of the acceleration sensor, taken along the line C-C of FIG. 20A.

The ground electrode 26B of this acceleration sensor in accordance with the sixth embodiment includes a base layer 26c of Ni and a surface layer 26b of Au. The ground electrode 26B also has openings 68B and 70B. These openings 68B and 70B are formed in only the surface layer 26b of Au, so that the base layer 26c of Ni is exposed through the openings 68B and 70B. In general, a conductive adhesive exhibits higher adhesion to Ni than to Au. Accordingly, the reliability in conductivity and shock resistance of the bonding layer is increased. Furthermore, as the entire surface of the vibrator 12 is covered with the Ni base layer 26c, the electrostatic capacitance of the vibrator 12 does not decrease.

The openings 68B and 70B can be formed by performing patterning on an Au layer utilizing an etching or laser trimming technique.

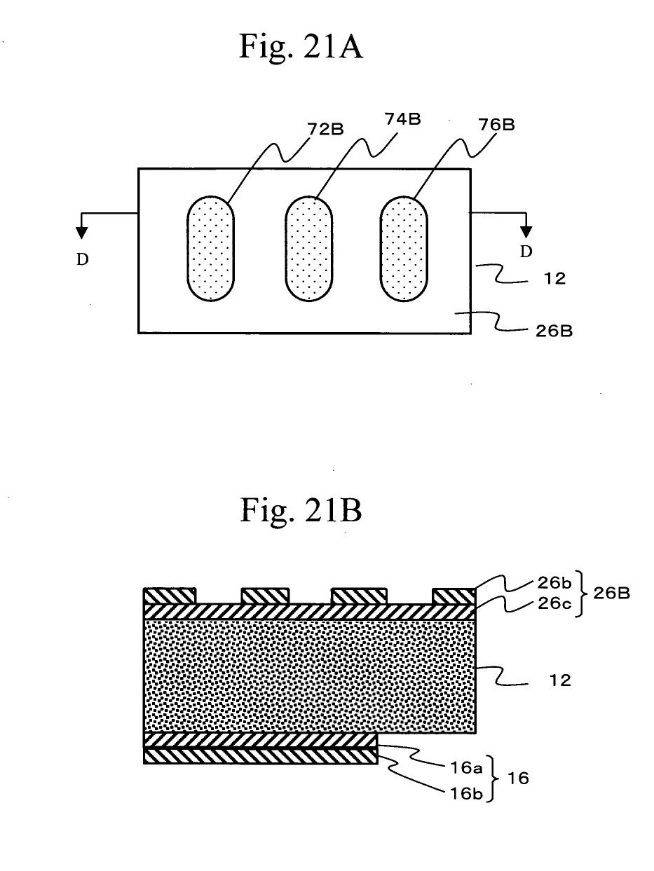

FIGS. 21A and 21B illustrate a modification of the acceleration sensor shown in FIGS. 20A and 20B. FIG. 21A is a plan view of this acceleration sensor, and FIG. 21B is a section view of the acceleration sensor, taken along the line D-D of FIG. 21A. In this modification, the ground electrode 26B has three oval-shaped openings 72B, 74B, and 76B. These openings 72B, 74B, and 76B extend in a different direction from the openings 68B and 70B shown in FIG. 20A. The vibrator 12 is exposed through the openings 72B, 74B, and 76B. The ground electrode 26B shown in FIGS. 21A and 21B have the same functions and effects as those of the ground electrode 26B shown in FIGS. 20A and 20B.

The base layer 26c may be made of a metal that is relatively easy to oxidize, such as Ti, Cu, or Al, instead of Ni.

(Seventh Embodiment)

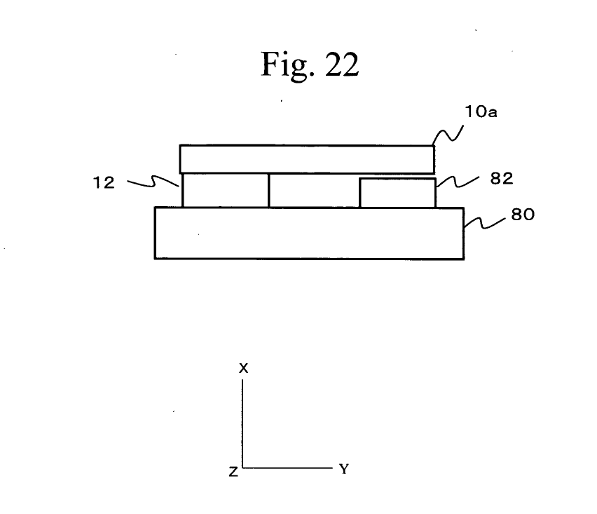

FIG. 22 is a side view of an acceleration sensor in accordance with a seventh embodiment of the present invention.

This acceleration sensor that includes the weight 10 and the vibrator 12 is mounted on a substrate 80 that is a printed wiring board or the like. The substrate 80 may be considered as a part of the acceleration sensor. The substrate 80 has the detection circuit shown in FIG. 3. It is of course possible for the substrate 80 to have some other desired circuit, as well as the detection circuit. The vibrator 12 is mounted on the substrate 80 so that the detection electrodes 14 and 16 face the substrate 80. Alternatively, the vibrator 12 may be mounted on the substrate 80 so that the ground electrode 26 faces the substrate 80.

In this manner, the acceleration sensor is mounted on the substrate 80 in a cantilevered state. However, the vibrator 12 might break when excessive impact is applied in the X-axis direction and stress concentrates on the vibrator 12. So as to reduce the impact and to protect the vibrator 12, a damper 82 is mounted on the substrate 80. This damper 82 is provided at a location facing the free end 10a of the weight 10. When acceleration is not applied in the X-axis direction, there is a gap between the bottom face of the weight 10 and the upper face of the damper 82. Even if excessive impact is applied in the X-axis direction, the movement of the free end 10a in the X-axis direction is restricted by the damper 82, so that stress does not concentrate on the vibrator 12. The damper 82 may be made of any material. For example, the damper 82 may be made of an insulating material such as alumina, and may be fixed onto the substrate 80 with an adhesive.

The damper 82 can be employed in all the foregoing embodiments and modifications. The damper 82 can also be employed in any acceleration sensor that is supported on a substrate in a cantilevered state.

(Eighth Embodiment)

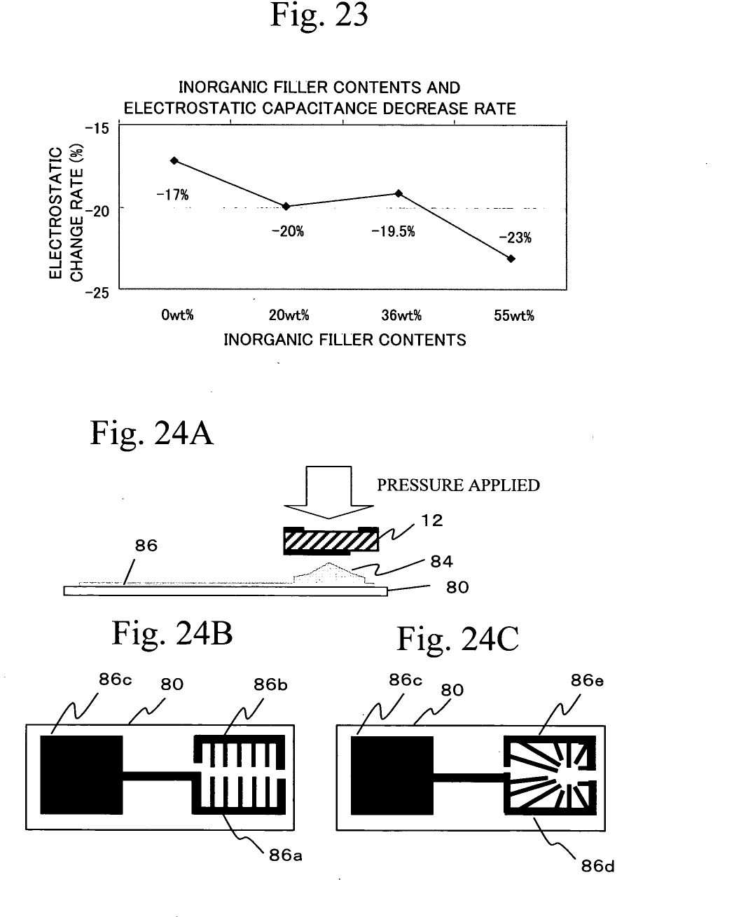

FIG. 23 illustrates the characteristics of an acceleration sensor in accordance with an eighth embodiment of the present invention. FIG. 23 is a graph showing the relationship between the inorganic filler contents in a conductive adhesive and the electrostatic capacitance change rate of the vibrator 12.

A conductive adhesive is used to attach a vibrator or a weight to a substrate. Such a conductive adhesive contains epoxy resin that has inorganic filler contents such as silica or alumina. When the amount (wt %) of the inorganic filler contents is changed, changes are caused in the hardening shrinkage or the elasticity of the adhesive, and the residual stress on the vibrator also changes. The change of the residual stress leads to a change of the electrostatic capacitance of the vibrator. This relationship is shown in the graph of FIG. 23. When the allowable value of the electrostatic capacitance change rate is set at −20%, the amount of the inorganic filter contents is set in the range of 0 wt % to 40 wt %. The amount of the inorganic filler contents is adjusted in this manner, so that decrease of the electrostatic capacitance can be controlled.

(Ninth Embodiment)

FIGS. 24A through 24C illustrate acceleration sensors in accordance with a ninth embodiment of the present invention. The ninth embodiment is characterized in that a wiring pattern is formed on the substrate so as to increase the strength of the conductive adhesive.

As shown in FIG. 24A, when the vibrator 12 is to be mounted on the substrate 80, an anisotropic conductive adhesive 84 is provided between the vibrator 12 and the substrate 80, and the vibrator 12 is then pressed down. The adhesive 84 is roundly applied by a dispensing or transfer technique. So as to press and spread the roundly applied anisotropic conductive adhesive 84 uniformly in the bonding area on the substrate 80, a wiring pattern 86 formed on the substrate 80 has a structure shown in FIG. 24B or FIG. 24C.

The wiring pattern 86 shown in FIG. 24B includes electrode parts 86a, 86b, and 86c. This wiring pattern 86 is formed by performing patterning on a metal film provided on the substrate 80 by etching or the like. The electrode parts 86a and 86b are connected to the detection electrodes 14 and 16 formed on the vibrator 12. The electrode parts 86a and 86b both have a comb-like pattern that serves as a guide for pressed anisotropic conductive adhesive. When pressed, the anisotropic conductive adhesive 84 moves along the guide and uniformly spreads over the electrode parts 86a and 86b. In this manner, the anisotropic conductive adhesive 84 is applied to the entire bottom face of the vibrator 12. As a result, the strength of the conductive adhesive can be increased, and the bonding layer becomes more reliable in terms of conductivity and shock resistance.

The comb-like patterns of electrode parts 86d and 86e shown in FIG. 24C are radially formed. These electrode parts 86d and 86e also serve as the guide for the pressed anisotropic conductive adhesive 84, and have the same functions and effects as the electrode parts 86a and 86b shown in FIG. 24B.

So far, the embodiments and modifications of the present invention have been described. However, the present invention is not limited to them, and other various modifications and changes may be made to the above embodiments.

Lastly, the above description will be summed up in order.

An acceleration sensor of the present invention includes: a vibrator that is polarized in one direction; a weight that is connected to the vibrator; and a pair of electrodes (the electrodes 14 and 16, for example) that are adjacent to each other in the polarization direction and are formed on a first face of the vibrator. The pair of electrodes are located on a diagonal line on the first face of the vibrator. With this electrode structure, voltage is constantly produced in the pair of electrodes, no matter which one of the three axes of the vibrator receives acceleration. Thus, a non-directional acceleration sensor can be realized. Also, the sensitivity to tri-axial acceleration can be adjusted by changing the sizes of the pair of electrodes in relation to the size of the vibrator, as will be described next.

Each of the electrodes may have a larger area than a fourth of the area of the first face, but smaller than a half of the area of the first face (as shown in FIG. 1B, for example). Thus, the sensitivity distribution ratio among the three axes can be easily determined.

Where the length of the vibrator in a direction perpendicular to the polarization direction is L, and the lengths of the pair of electrodes are L1 and L2, the relationship among the lengths can be expressed as: 0.5<L1(=L2)/L<1. The lengths of the pair of electrodes are determined within this range, so that the sensitivity distribution ratio among the three axes can be easily set at a desired value.

The first face of the vibrator has two or more exposed regions (the exposed regions 20 and 22, for example) that are not covered with the pair of electrodes. These exposed regions are arranged on the other diagonal line on the first face. The sizes of the exposed regions affect the sensitivity distribution ratio among the three axes. Therefore, the sensitivity distribution ratio among the three axes can be easily set at a desired value by arbitrarily selecting the sizes of the exposed regions.

The acceleration sensor may further include another pair of electrodes (the electrodes parts 14b and 16b, for example) that are located on the other diagonal line on the first face of the vibrator. With another pair of electrodes in addition to the pair of electrodes (14a and 16a), an acceleration sensor that can detect tri-axial acceleration can be realized.

Another pair of electrodes (14b and 16b) may each have an area smaller than each area obtained by dividing the first face of the vibrator into two equal parts, with the polarization direction being the dividing line. This is a specific example of another pair of electrodes. In this case, the pair of electrodes are electrically connected to another pair of electrodes that are adjacent to each other in a direction perpendicular to the polarization direction.

The polarization direction of the vibrator may be perpendicular to the longitudinal direction of the plate-like weight (as shown in FIG. 1A, for example). When acceleration in the polarization direction is applied to the vibrator, the acceleration can be detected in the directions of all the three axes. At least two of the three axes have different voltages in the detection electrodes (as shown in FIG. 1B, for example). It is thus possible to detect the directions of acceleration.

Alternatively, the polarization direction of the vibrator may be the same as the longitudinal direction of the plate-like weight (as shown in FIG. 9A, for example). With this relationship between the weight and the polarization direction of the vibrator, it is also possible to obtain an acceleration sensor that can detect acceleration in all the three axial directions.

Further, a differential amplifier to be connected to the pair of electrodes may be employed (as shown in FIG. 3) so as to differential-amplify the voltage in the pair of electrodes. With this differential amplifier, the detection sensitivity to acceleration can be increased.

The present invention also provides an acceleration sensor that includes: a vibrator that is polarized in one direction; a weight that is connected to the vibrator; and two electrodes (the electrodes 44 and 46, for example) that are arranged at such locations as to divide the first face of the vibrator into two asymmetric parts. The facing edges of the two electrodes are tilted with respect to the polarization direction of the vibrator. With this electrode structure, it is also possible to detect tri-axial acceleration. Furthermore, the sensitivity distribution ratio among the three axes can be easily adjusted by changing the dividing lines.

In an example of arrangement of the two electrodes, one of the two electrodes may lie across all the four equally divided regions of the first face (as shown in FIG. 15B, for example).

In another example of arrangement of the two electrodes, the two electrodes may have different areas or area ratios from each other (as shown in FIG. 15B).

Further, a metal film (the ground electrode 26A, for example) may be formed on a second face of the vibrator that is situated on the opposite side to the first face of the vibrator. The metal film is patterned so as to expose part of the vibrator, and the second face is secured to the weight with an adhesive (as shown in FIGS. 18A through 18C, 19A, 19B, 20A, 20B, 21A, and 21B). As the adhesive is applied to the exposed part of the vibrator, the adhesive strength can be increased.

Alternatively, a multi-layer metal film may be formed on the second face that is situated on the opposite side to the first face of the vibrator. The surface layer of the multi-layer metal film is patterned so as to expose part of the inner metal layer. The second face is fixed to the weight with an adhesive. If the inner metal layer exhibits a higher adhesion than the outer metal layer, a higher adhesive strength can be achieved accordingly. Furthermore, as the vibrator is covered with the inner metal layer, the electrostatic capacitance of the vibrator does not decrease.

It is also possible to employ a structure in which the corners of the electrodes are set back from the corners of the vibrator (as shown in FIGS. 17A and 17D). With this structure, chipping can be prevented when the vibrator is processed by a dicing technique or the like.

It is also possible to employ a structure in which the edges of the electrodes are set back from the edges of the vibrator (as shown in FIGS. 17A through 17G). With this structure, chipping can be prevented when the vibrator is processed by a dicing technique or the like.

An acceleration sensor of the present invention may include a substrate (the substrate 80). In this acceleration sensor, the first face of the vibrator is attached to the substrate with an adhesive (as shown in FIGS. 22 and 24A through 24C).

The substrate may have a metal film (the electrode parts 86a and 86b or 86d and 86e) formed at locations facing the first face of the vibrator. The metal film is patterned so as to guide the adhesive when the vibrator is to be attached to the substrate (as shown in FIGS. 24B and 24C). Through the patterning, the adhesive spreads over the entire bonding face, and the adhesive strength is increased.

An acceleration sensor of the present invention may have a substrate, and the weight is supported on the substrate in a cantilevered state, with the vibrator being interposed in between. In this structure, a damper (the damper 82) may be formed on the free end of the weight. This damper restricts movement of the free end of the weight. In this structure, stress does not concentrate on the vibrator, and the vibrator can be protected from damage, even if excessive impact is applied in one particular direction.

As described so far, the present invention can provide a small-sized, highly reliable acceleration sensor that can detect tri-axial acceleration, employing a simple electrode structure for a vibrator.

1. An acceleration sensor comprising:
a vibrator that is polarized in one direction;
a weight that is connected to the vibrator; and
a pair of electrodes that are adjacent to each other in the direction of the polarization and are formed on a first face of the vibrator, the pair of electrode being located on a diagonal line on the first face.

2. The acceleration sensor as claimed in claim 1, wherein the pair of electrodes each has an area that is larger than a fourth of the area of the first face, but smaller than a half of the area of the first face.

3. The acceleration sensor as claimed in claim 1, wherein the relationship between the length of the vibrator and the lengths of the pair of electrodes is expressed as follows:
0.5<L1(=L2)/L<1
where L represents the length of the vibrator in a direction perpendicular to the polarization direction, and L1 and L2 represent the lengths of the pair of electrodes.

4. The acceleration sensor as claimed in claim 1, wherein the first face of the vibrator has a plurality of exposed regions that are not covered with the pair of electrodes, the plurality of exposed regions being located on the other diagonal line on the first face.

5. The acceleration sensor as claimed in claim 1, further comprising another pair of electrodes that are located on the other diagonal line on the first face.

6. The acceleration sensor as claimed in claim 5, wherein the another pair of electrodes each has an area that is smaller than the area of each half of the first face of the vibrator divided in the polarization direction.

7. The acceleration sensor as claimed in claim 6, wherein each electrode of the pair of electrodes is electrically connected to each corresponding electrode of the another pair of electrodes that are adjacent to each other in a direction perpendicular to the polarization direction.

8. The acceleration sensor as claimed in claim 1, wherein the polarization direction of the vibrator is perpendicular to the longitudinal direction of the weight that takes on a plate-like shape.

9. The acceleration sensor as claimed in claim 1, wherein the polarization direction of the vibrator is the same as the longitudinal direction of the weight that takes on a plate-like shape.

10. The acceleration sensor as claimed in claim 1, further comprising a differential amplifier that is connected to the pair of electrodes and differential-amplifies voltage produced in the pair of electrodes.

11. An acceleration sensor comprising:
a vibrator that is polarized in one direction;
a weight that is connected to the vibrator; and
two electrodes that are arranged in such a manner as to divide a first face of the vibrator into two asymmetric parts, the two electrodes having facing edges tilted with respect to the polarization direction of the vibrator.

12. The acceleration sensor as claimed in claim 11, wherein one of the two electrodes lies across all parts of the first face that is divided into four equal parts.

13. The acceleration sensor as claimed in claim 11, wherein the two electrodes have different areas from each other.

14. The acceleration sensor as claimed in claim 1, further comprising a metal film that is patterned on a second face of the vibrator in such a manner that the vibrator is partially exposed, the second face being situated on the opposite side to the first face of the vibrator,
wherein the second face is fixed to the weight with an adhesive.

15. The acceleration sensor as claimed in claim 1, further comprising a multi-layer metal film that is formed on a second face on the opposite side to the first face of the vibrator, the multi-layer metal film having a surface layer patterned in such a manner that an inner metal film is partially exposed,
wherein the second face is fixed to the weight with an adhesive.

16. The acceleration sensor as claimed in claim 1, wherein the electrodes have corner parts set back from the corresponding corners of the vibrator.

17. The acceleration sensor as claimed in claim 1, wherein the edges of the electrodes are set back from the edges of the vibrator.

18. The acceleration sensor as claimed in claim 1, further comprising a substrate,
wherein the first face of the vibrator is attached to the substrate with an adhesive.

19. The acceleration sensor as claimed in claim 18, wherein
the substrate has a metal film formed at a location facing the first face of the vibrator; and
the metal film is patterned so as to guide the adhesive when the vibrator is attached to the substrate.

20. The acceleration sensor as claimed in claim 1, further comprising a substrate,
wherein:
the weight is supported on the substrate in a cantilevered state, with the vibrator being interposed in between; and
a damper is formed on the substrate at a location facing a free end of the weight, the damper restricting movement of the free end.
